(19) United States
(12) Patent Application Publication
(10) Pub. No.: US 2006/0082018 A1
(43) Pub. Date: Apr. 20, 2006

(54) Method and apparatus for making decorative laminates

(76) Inventor: Yuval Regev, Carmei Yosef (IL)

Correspondence Address: Martin Moynihan;c/o ANTHONY CASTORINA, SUITE 207, 2001 JEFFERSON DAVIS HIGHWAY, ARLINGTON, VA, 22202, US

(21) Appl. No.: 10/965,832

(22) Filed: Oct. 18, 2004

(51) Int. Cl. B29C 65/00; B32B 37/00; B32B 38/04; B29C 45/14

(52) U.S. Cl. 264/259; 156/247; 156/228; 156/261; 156/510; 156/580

(57) ABSTRACT

A method and apparatus for making decorative articles having desired decorative patterns thereon, by producing a decorative strip having a pattern portion of the desired pattern, and an extraneous scrap portion to be removed in order to define the desired pattern; applying the decorative strip to a separation assembly including a pressure applicator engaging one side of the decorative strip and configured according to the scrap portion to be removed, and a counter-pressure device end the opposite side of the decorative strip and configured according to the pattern portion, so as to separate the scrap portion from the pattern portion; and removing the separated scrap portion. In one described preferred embodiment, the pressure applicator includes a plurality of pins arrayed according to the configuration of the scrap portion to be removed; and in other described embodiments, the counter-pressure device also includes a plurality of pins; but arrayed according to the pattern portion to be retained.

### FIELD AND BACKGROUND OF THE INVENTION

The present invention relates to a method and apparatus for making decorative articles. The invention is particularly useful for making decorative laminates in the form of emblems nameplates and the like, of a thermoplastic synthetic resin such as described in U.S. Pat. No. 5,589,022, and the invention is therefore described below particularly with respect to this application, but it will be appreciated that the invention could be used in many other applications as well.

U.S. Pat. No. 5,589,022 describes a method of making emblems of thermoplastic synthetic resin by producing a laminate including a decorative layer supported on a backing layer, and then processing the decorative layer to define a pattern portion of the desired pattern to be retained, and an extraneous scrap portion to be removed. One of the drawbacks in manufacturing decorative laminates in general, and decorative emblems in particular, is the difficulty of removing the extraneous portions in an efficient and clean manner, and particularly in a manner which lends itself to mass production. The present invention is directed primarily to overcoming this drawback.

### OBJECTS AND BRIEF SUMMARY OF THE INVENTION

An object of the present invention is to provide a method and apparatus for making decorative articles from decorative strips in a manner which better assures the complete removal of the extraneous scrap portion of the decorative strip from the pattern portion. Another object of the invention is to provide a method and apparatus for marking decorative articles in a manner susceptible to high-volume, low-cost production.

According to one aspect of the present invention, there is provided a method of making decorative articles having desired decorative patterns thereon, comprising: producing decorative strip having a pattern portion of the desired pattern; and an extraneous scrap portion to be removed in order to define the desired pattern; applying the decorative strip to a separation assembly including a pressure applicator engaging one side of the decorative strip and configured according to the scrap portion to be removed, and a counter-pressure device engaging the opposite side of the decorative strip and configured according to the pattern portion, so as to separate the scrap portion of the decorative strip from the pattern portion; and removing the separated scrap portion.

Several embodiments of the invention are described below for purposes of example. According to further features in the described preferred embodiments, the pressure applicator includes a plurality of pins having tips engageable with the one side of the decorative strip and arrayed according to the configuration of the scrap portion of the decorative strip to be removed. Preferably, the plurality of pins are adjustable in the pressure applicator to permit changing the array configuration of the pin tips.

According to further features in some described preferred embodiments, the counter-pressure device also includes a plurality of pins having tips engageable with the opposite side of the decorative strip and arrayed according to the configuration of the pattern portion of the decorative strip to be retained.

According to another aspect of the present invention, there is provided, apparatus for making decorative strips having pattern portion of a desired pattern, and extraneous scrap portions to be removed in order to define the desired pattern; said apparatus comprising a separation device including a pressure applicator configured according to the scrap portion and engageable with one side of the decorative strip, and a counter-pressure device engageable with the opposite side of the decorative strip and configured according to the pattern portion; and a drive for driving the pressure applicator towards the counter-pressure device to forcibly separate the scrap portion of the decorative strip from the pattern portion.

As will be more particularly described below, making decorative articles in accordance with the foregoing features not only better assures complete removal of the extraneous scrap portions of the decorative strips while retaining only the patterned portion, but also enables the production of such decorative strips in an efficient, high-volume, low-cost manner.

Further features and advantages of the invention will be apparent from the description below.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 illustrates a batch type apparatus constructed in accordance with the present invention for making decorative laminates, particularly emblems nameplates and the like, e.g., as described in the above-cited U.S. Pat. No. 5,589,022;

FIG. 2 schematically illustrates the initial decorative laminate before processed in accordance with the present invention;

FIG. 3 illustrates the laminate of FIG. 2 after being processed in accordance with the present invention to separate the extraneous scrap portion and to retain the pattern portion defining the desired pattern;

FIGS. 4-12 illustrate various stages of processing the decorative laminate with the apparatus of FIG. 1;

FIG. 13 illustrates a modification in the construction of the apparatus of FIG. 1;

FIGS. 14-19 schematically illustrate a universal-press type of apparatus constructed in accordance with the present invention permitting convenient and quick set-up of the apparatus according to the decorative pattern to be produced;

FIG. 20-25 schematically illustrate a computer-controlled universal-press type apparatus constructed in accordance with the present invention;

FIG. 26 illustrates a linear-type of continuous production system for producing decorative laminates in accordance with the present invention; and

FIG. 27 illustrates a rotary-type continuous production system for producing decorative laminates in accordance with the present invention.

It is to be understood that the foregoing drawings, and the description below, are provided primarily for purposes of facilitating understanding the conceptual aspects of the invention and various possible embodiments thereof, including what is presently considered to be a preferred embodiment. In the interest of clarity and brevity, no attempt is made to provide more details than necessary to enable one skilled in the art, using routine skill and design, to under and practice the described invention. It is to be fiercer understood that the embodiments described are for purposes of example only, and that the invention is capable of being embodied in other forms and applications than described herein.

### DESCRIPTION OF PREFERRED EMBODIMENTS

Overview

The present invention relates to a method and apparatus for making decorative articles having a desired decorative pattern, and is described below with respect to a number of preferred embodiments. In the described preferred embodiments, a decorative strip is produced having a pattern portion of the desired pattern, and an extraneous scrap portion to be removed in order to define the desired pattern. The decorative strip is applied to a separation device including a pressure applicator engaging one side of the decorative strip and configured according to the scrap portion to be removed, and a counter-pressure device engaging the opposite side of the decorative strip and configured according to the pattern portion, so as to separate the scrap portion from the pattern portion. The separated scrap portion, is then removed.

ID the preferred embodiments of the invention described below, the pressure applicator includes a plurality of pins having tips engageable with the respective side of the decorative strip and arrayed according to the configuration of the scrap portion to be removed.

The foregoing features, as well as many additional features, will be more fully described below with respect to the illustrated preferred embodiments.

The Decorative Laminate

As indicated above, the decorative strips processed by the method and apparatus of the present invention may be of a laminate construction such as described in U.S. Pat. No. 5,589,022, the contents of which are incorporated herein by reference. Such a laminate, in its initial form, is illustrated in FIG. 2, and is generally designated 10. It is shown as including: a bottom layer 11 of a strippable material, such as a silicone resin; an intermediate layer 12 of a thermo-plastic resin, such as foamed polyurethane, coated with a pressure-sensitive adhesive and an upper decorative layer 13, such as a colored plastic or a vapor-deposited film of aluminum, chromium or other metal. While laminate 10 illustrated in FIG. 2 includes only the foregoing three layers, it will be appreciated that the decorative strip could be of other constructions having fewer or more layers.

As briefly described above, decorative laminate 10 illustrated in FIG. 2 is processed to define a pattern portion of the desired pattern to be returned, and an extraneous scrap portion to be removed. In FIGS. 2 and 3, the pattern portion to be retained is designated 14, and the extraneous scrap portion to be removed is designated 15a and 15b located in the inner region and outer region, respectively, with respect to the pattern portion 14.

In the preferred embodiments described below, the decorative laminate 10 is subjected to a separation operation wherein the extraneous scrap portions 15a, 15b are separated from the pattern portion 14. The drawing illustrate various types of apparatus for performing the above separation processes in accordance with the present invention.

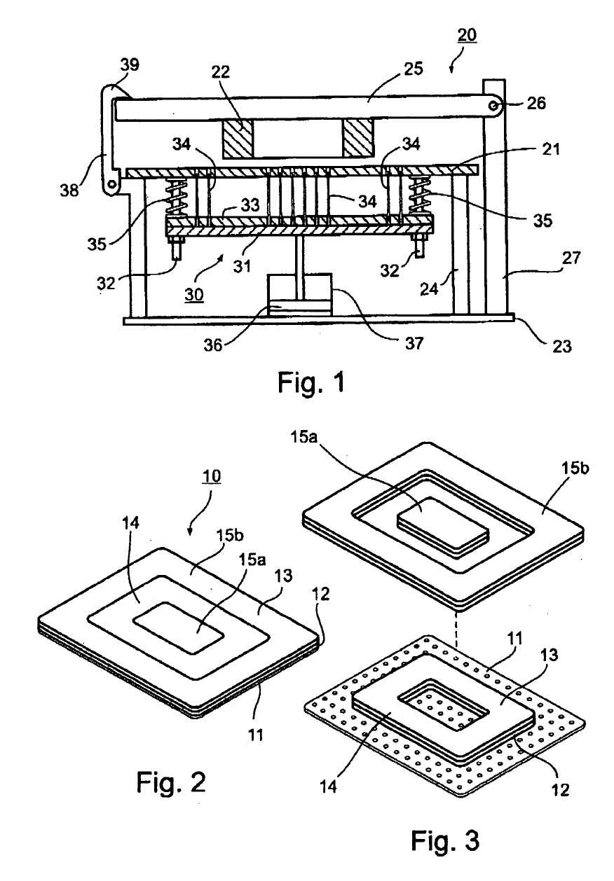

The Simplified Batch Apparatus of FIGS. 1 and 4-13

FIGS. 1 and 4-13 illustrate one form of simplified batch apparatus constructed in accordance with the present invention for performing the separation operation. As seen in FIG. 1, the illustrated apparatus, includes a first pressure member 21 and a second pressure member 22 movably mounted with respect to pressure member 21. The two pressure members engage opposite sides of the laminate, shown at 10 in FIG. 2, to produce an emblem, nameplate, or other decorative article having a desired decorative pattern thereon. Pressure member 21 is fixedly mounted on a base 23 by a plurality of uprights 24. Pressure member 22 is carried on the underside of a beam or plate 25 pivotally mounted at one end 26 to a vertical upright 27 also supported on base 23.

Pressure member 22 is in the configuration of the desired pattern to be produced namely pattern 14 shown in FIGS. 2 and 3. Thus, when laminate 10 is introduced between the two pressure members 21 and 22, and plate 25 supporting pressure member 22 is pivoted to its closed position to press the laminate between it and the fixed pressure member 21, the three layers 11, 12 and 13 of the laminate are bonded together in the regions engaged by the upper pressure member 22. The illustrated apparatus further includes a separation device, generally designated 30, effective to physically separate the extraneous scrap portions 15a, 15b from the decorative laminate 10, leaving the pattern portion 14 defining the desired pattern directly held between the two pressure members 21, 22.

Thus, as shown in FIG. 1, separation device 30 includes a pressure plate 31 slidably supported below pressure member 21 by a plurality of rods 32 fixed to the underside of member 21 and received within openings formed in plate 31. Rods 32 further support a mounting plate 33 formed with a plurality of openings receiving a plurality of pins 34. Each pin 34 has one end engaging pressure plate 31, and an opposite end aligned with an opening formed in the lower pressure member 21. Mounting plate 33 and pressure plate 31 are urged to their lower positions illustrated in FIG. 1 by a plurality of springs 35 received on the rods 32 between pressure member 21 and mounting plate 33. Pressure plate 31, mounting plate 33, and the plurality of pins 34 mounted by the mounting plate, are driven to upper positions by a piston 36 movable within a cylinder 37.

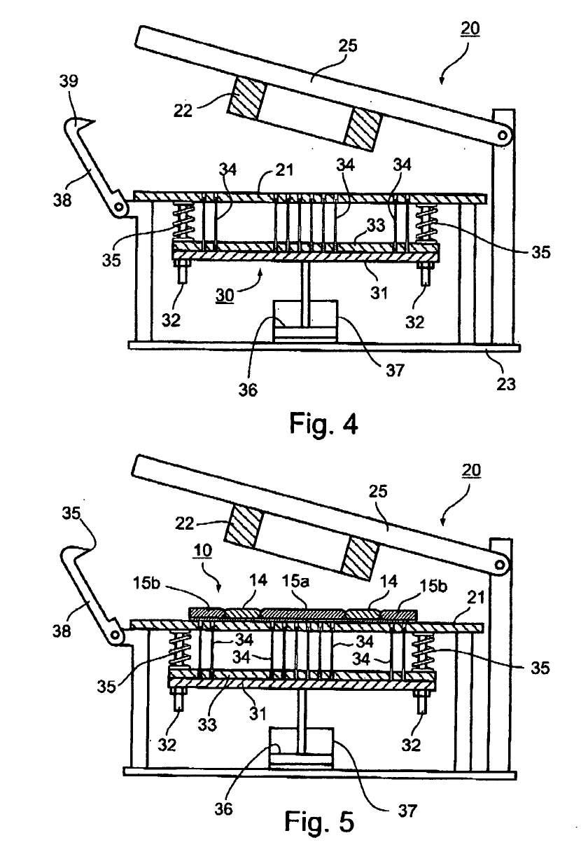

Pivotal plate 25 carrying the upper pressure member 22 may be pivoted about pivot 26 to either a closed operative position as shown in FIG. 1, or to an open position as shown in FIG. 4 for insertion of the initial decorative laminate to be processed to produce the desired decorative article, such as an emblem, nameplate, etc., of the desired decorative pattern. Pivotal plate 25 is locked in its closed position by a clumping mechanism including a clamping bar 38 pivotal at one end to one of the uprights 27 of the machine base and formed with a hook 39 at its opposite end engageable with the outer surface of pivotal plate 25.

FIGS. 4-12 illustrate the various conditions of the apparatus of FIG. 1 in the course of processing an initial decorative laminate 10 (FIG. 2) to produce an emblem or the like of the desired decorative pattern.

FIG. 4 illustrates the open condition of the apparatus to permit insertion of the initial decorative laminate 10. FIG. 5 illustrates the decorative laminate 10 placed on top of the fixed pressure member 21 while the pivotal plate 25 is in its open position. FIG. 5 also illustrate the various portions of the initial decorative laminate 10 namely the pattern portion 14 defining the desired pattern of the emblem, the inner extraneous scrap portion 15a to be removed, and the outer extraneous scrap portion 15b also to be removed. As described above, the upper pressure member 22 carried by pivotal plate 25 is configured according to the desired pattern portion 14.

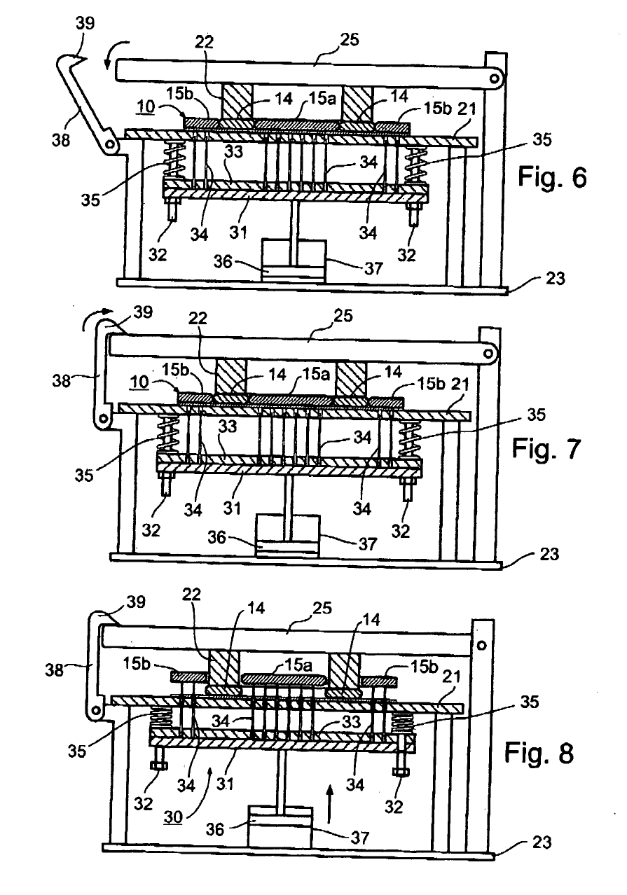

Pivotal plate 25 is then closed to press the upper pressure member 22 against the decorative laminate 10 on the lower pressure member 21 (FIG. 6), and is clamped in such position by clamping element 38 (FIG. 7). This causes the pattern portion 14 of the decorative laminate 10 to be firmly pressed between the upper pressure member 22 and the lower pressure member 21, whereas the extraneous scrap portions 15a, 15b, not engaged by the upper pressure member 22 are not firmly held by the two pressure members.

FIG. 8 illustrates the activation of the separation device 30 for separating the extraneous scrap portions 15a, 15b from the pattern portion 14 of the initial decorative laminate. Thus, as shown in FIG. 8, piston 36 of the separation device 30 is actuated to drive pressure plate 31 upwardly, and thereby the plurality of pins 34 upwardly through openings in the lower pressure member 21. As described above, the plurality of pins 34 are arranged so that their upper tips, engaging the respective side of the laminate, are arrayed according to the configuration of the extraneous scrap portions 15a, 15b to be removed. Thus, this upward movement of the pins separates the extraneous scrap portions 15a, 15b of the laminate firm the pattern portion 14, as shown in FIG. 8.

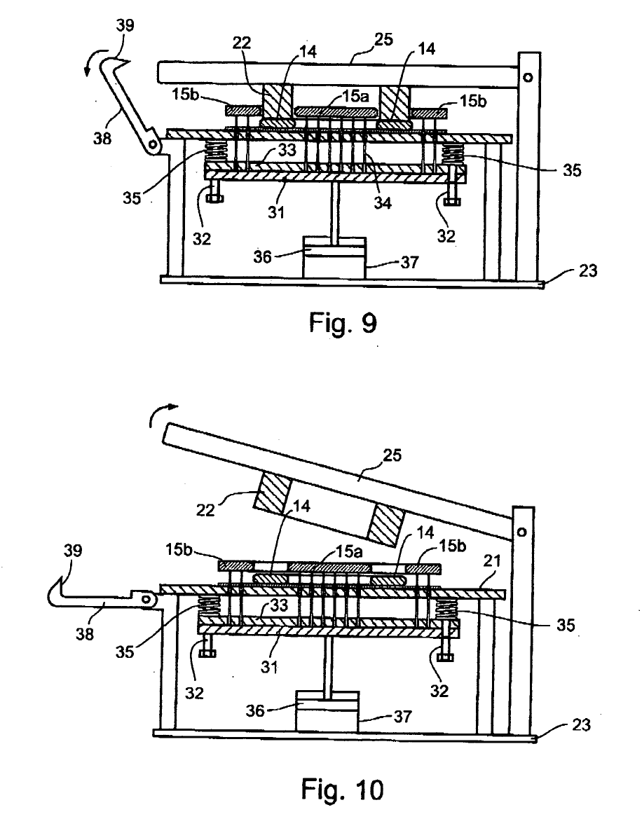

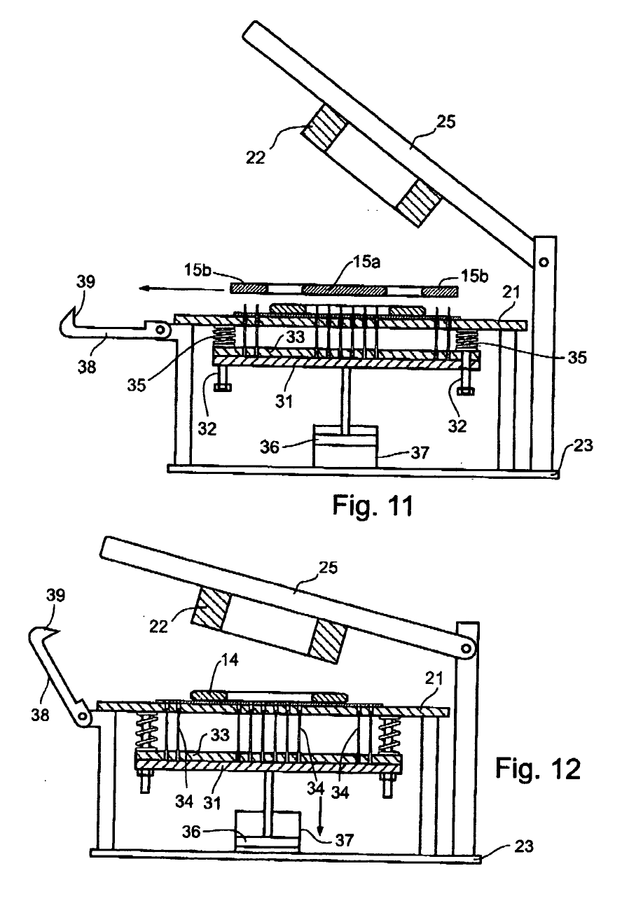

Pivotal plate 25 is then unlocked (FIG. 9) and pivoted to its open position (FIG. 10) to permit removal of the extraneous scrap portions 15a, 15b (FIG. 11). Piston 36 of the separation assembly 30 is then moved to its lower position (FIG. 12) to return the group of pins 34 to their initial lower positions, to thereby permit removal of the pattern portion 14 carrying the desired pattern.

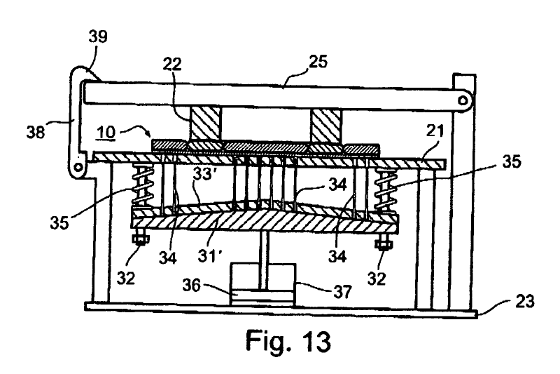

As shown for example in FIG. 12 pressure plate 31 is a flat plate, and therefore it will drive all the pins uniformly and simultaneously against the respective side of the laminate. FIG. 13 illustrates a modification, wherein the backing plate, therein designated 31′, is shaped such that it will drive the pins 34 non-uniformly against the respective side of the laminate 10. This facilitates cleaner separation and removal of the scrap portions 15a, 15b by spreading the stresses produced by the upward movement of the pins.

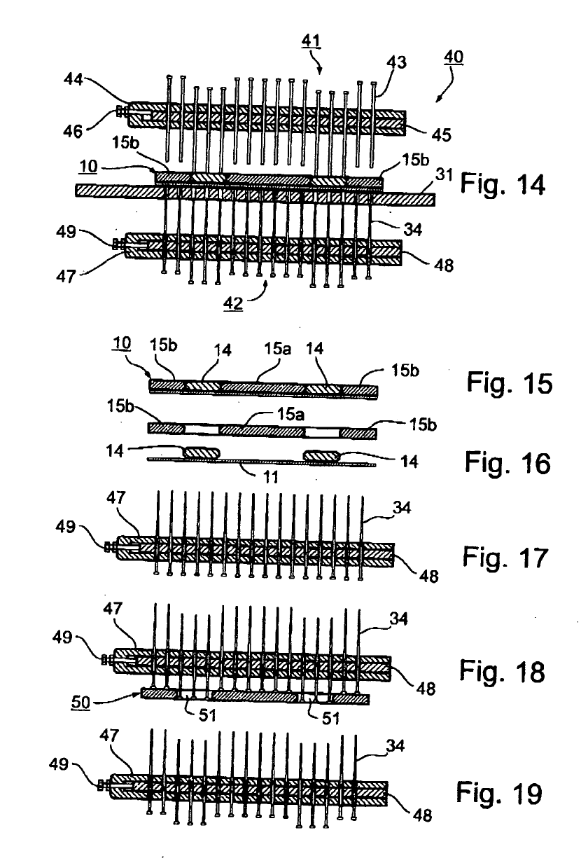

The Universal-Type Apparatus of FIG. 14-19

FIGS. 14-19 illustrate the invention implemented in a universal-type apparatus permitting convenient set-up for producing different types of decorative patterns. The illustrated universal-type apparatus, therein generally designated 40, also includes a lower apertured pressured member 31 overlying a separation device including a plurality of pins 34 driven through pressure member 31 to separate the extraneous scrap portions 15a, 15b of the decorative laminate 10 from the pattern portion 14 in the manner described above with respect to FIGS. 1-13. In this case, however, instead of including an upper pressure member (corresponding to pressure member 22 in FIGS. 1-13) configured according to the desired pattern to be produced, apparatus 40 includes another group of pins in the form of a pin assembly, generally designated 41, which may be preset according to the desired pattern to be produced.

As further seen in FIG. 14, pins 34 arrayed according to the shape of the extraneous scrap portions to be removed are carried by a pin assembly, generally designated 42, permitting pins 34 to be preset in a convenient manner according to the shape of the scrap portions to be removed.

Upper pin assembly 41 includes a plurality of pins 43 mounted within aligned openings in opposed sections of a U-shaped holder plate 44 and also within openings in a locking plate 45 received between the two sections of the holder plate. Locking plate 45 is movable by a screw 46 with respect to the holder plate 44 to a locking position for locking the pins 43, or to a releasing position for releasing the pins for setting up according to any desired configuration of their inner tips. Thus, by rotating screw 46 to its release position, pins 43 may be vertically moved within holder plate 44 to array their inner tips according to the configuration of the deiced pattern to be produced. Rotating screw 46 to its locking position moves locking plate 45 to lock the pins in position.

The lower pin assembly 42 crying pins 34 to be configured according to the extraneous scrap portions of the laminate to be removed, as described above, also includes a U-shaped holder plate 47 and a locking plate 48 lockable by means of a screw 49. Accordingly, screw 49 in lower pin assembly 42 may also be moved to its releasing position in order to permit the pins 34 to be vertically moved such that their upper tips define the configuration of the extraneous scrap portions to be separated and removed, and then tightened in order to fix the pins in such position.

The apparatus schematically illustrated in FIG. 14 is used in substantially the same manner as described above for producing decorative laminates having the desired decorative pattern thereon. The apparatus in FIG. 14, however, permits quick and convenient setting-up of the pins 43 in the upper pin assembly 41, as well as the pins 34 in the lower pin assembly 42, according to the particularly decorative pattern to be produced.

FIG. 15 illustrates the laminate 10 in its initial form, as described above with respect to FIG. 2, as including the pattern portion 14 defining the desired pattern to be produced, and the extraneous scrap portions 15a, 15b to be separated and removed. FIG. 16 illustrates the extraneous scrap portions 15a, 15b after separation from the pattern portion 14.

FIGS. 17-19 illustrate three stages in setting-up the lower pin assembly 42 in order to array their upper tips according to the configuration of the extraneous scrap portions 15a, 15b of the laminate to be separated and removed. Thus, FIG. 17 illustrates the initial condition of pin assembly 42, wherein all the pins 34 are in their initial positions. FIG. 18 illustrates the condition of the pin assembly after screw 49 has been moved to its releasing condition permitting locking plate 48 to release the pins for vertical movement according to the desired array of tips. After the pins have been so positioned, screw 49 would be tightened to cause locking bar 48 to lock the pins in their positions, as shown in FIG. 19.

FIG. 18 also illustrates a set-up plate 50 which may be provided to facilitate setting-up the pins in proper vertical positions. Thus, as shown in FIG. 18, set-up plate 50 is provided with recessed formations 51 corresponding to the scrap portions 15a, 15b to be separated and removed in order to produce the pattern 14. Thus, when the screw 49 is moved to its releasing position, the pins aligned with the recess formations 51 will drop so as to lower their upper tips, whereby the upper tips of the remaining pins will be arrayed according to the configuration of the extraneous scrap portions 15a, 15b to be removed, as shown in FIG. 19.

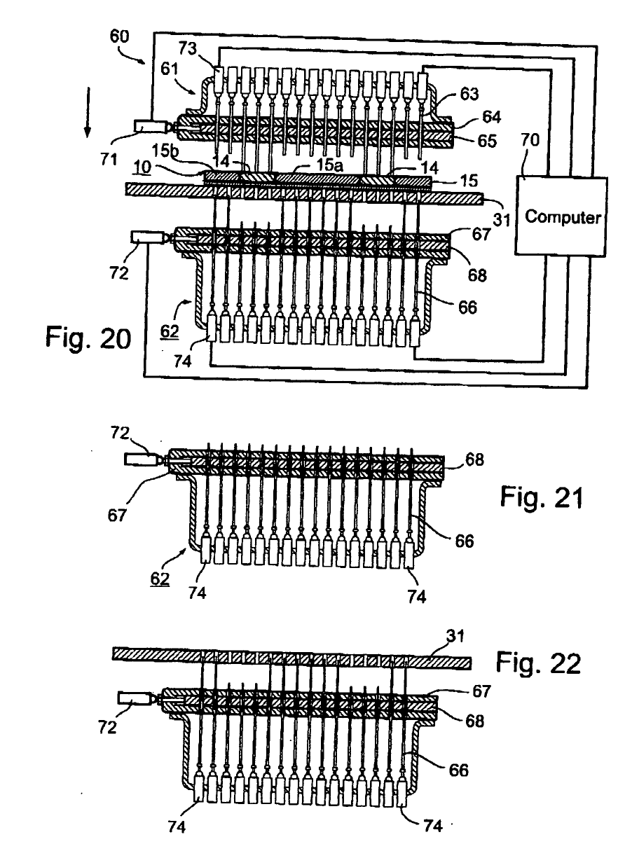

The Computer-Controlled Apparatus of FIGS. 20-25

FIGS. 20-25 illustrate the invention implemented in a computer-controlled apparatus. The computer-controlled apparatus is similar to the universal-type apparatus of FIGS. 14-19, but utilizes a computer for setting-up the pins in the upper and lower pin assemblies, and also for driving the pins in order to remove the extraneous scrap portions from the term portions of the decorative laminate to be produced.

The overall computer-controlled apparatus is schematically illustrated in FIG. 20 and is therein generally designated 60. It includes an upper pin assembly 61 and a lower pin assembly 62, similar to pin assemblies 41 and 42, respectively, in the universal-type apparatus of FIGS. 14-19. The upper pin assembly 61 includes a plurality of pins 63 vertically adjustable within a U-shaped holder plate 64 and lockable in any desired vertical position by a locking plate 65. Similarly, the lower pin assembly 62 includes a plurality of pins 66 vertically adjustable within a U-shaped holder plate 61 and lockable in any desired vertical position by a locking plate 68.

The setting-up of the pins in the two assemblies 61, 62, as well as the driving of the pins in order to produce the desired pattern is controlled by a computer 70.

Thus, computer 70 controls a solenoid 71 to actuate locking plate 65 of the upper pin assembly 61 to its locking and releasing positions. Computer 70 also controls solenoid 72 in the lower pin assembly 62 to actuate locking plate 68 of the lower pin assembly 62 to either its locking or releasing positions. Computer 70 flier controls a plurality of solenoids 73, one for each of the pins 63 in the upper pin assembly 61, and a further plurality of solenoids 74, one for each of the pins 66 in the lower pin assembly 62.

Thus, computer 70 may be used to control the two solenoids 71, 72, to release the pins 63, 66 in the upper and lower pin assembly 61, 62, and then to control solenoids 73, 74, to properly position the pins 63, 66, during the set-up operation. During the actual separation operation, computer 70 controls solenoids 73 of the upper pin assembly 61 to drive pins 63 against the upper side of laminate 10 at the locations corresponding to the pattern portion 14 to be retained. Concurrently, computer 70 controls solenoid 74 of the lower pin assembly 62 to drive pins 66 against the underside of laminate 10 at the locations thereof corresponding to the scrap portions 15a, 15b of the laminate to be removed in order to produce the desired pattern as described above.

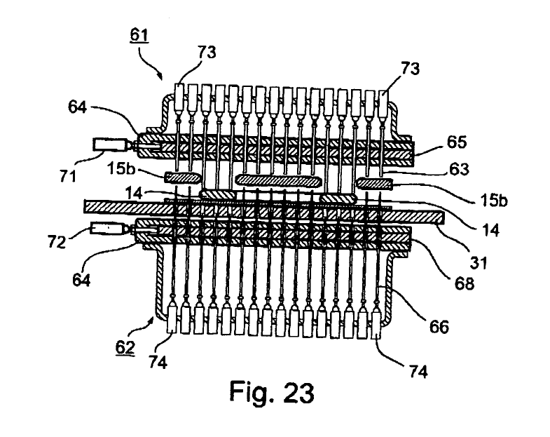

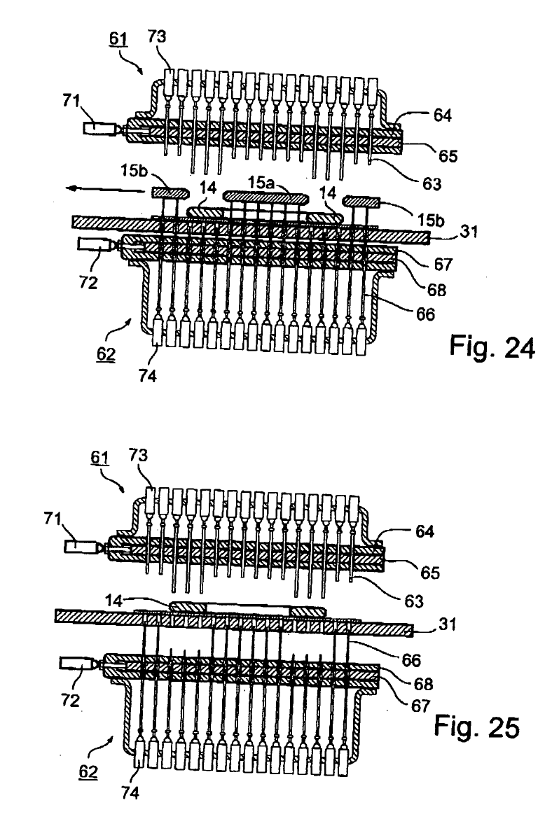

FIG. 21 illustrates the initial positions of the pins 66 in the lower pin assembly 62; FIG. 22 illustrates the pins 66 after having been set-up according to the configuration of the extraneous scrap portions to be removed; FIG. 23 illustrates the positions of the pins in both the upper pin assembly 61 and the lower pin assembly 62 during the separation process; FIG. 24 illustrates the condition of the apparatus during the removal of the separated scrap portions; and FIG. 25 illustrates the condition of the apparatus after the pins 66 of the lower pin assembly 62 have been returned to their initial positions to permit removal of the final product, i.e., the produced decorative laminate.

### EXAMPLES OF EDUCATION LINES

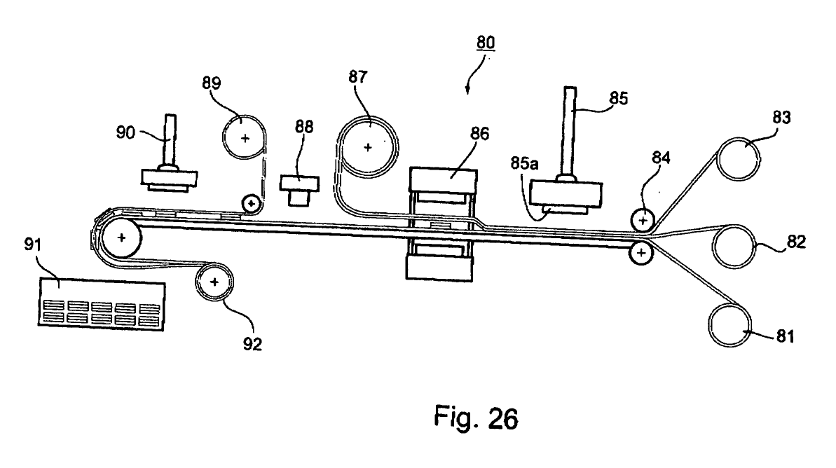

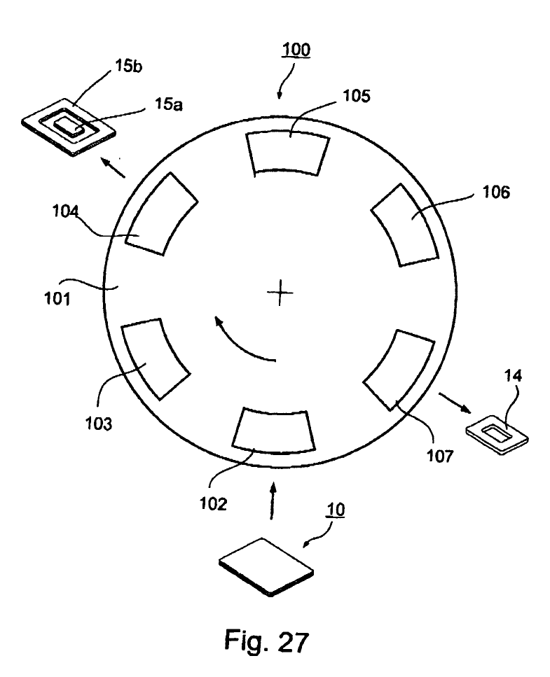

FIG. 26 schematically illustrates the invention implemented in a linear-type production line, whereas FIG. 27 illustrates the invention implemented in a rotary-type production line.

The linear-type production line illustrated in FIG. 26, and therein generally designated 80, includes three supply rollers 81, 82, 83, for supplying the sheet material for the three layers 11, 12 and 13, respectively, of the laminate 10, as illustrated in FIG. 2. Thus, the lower roller 81 would supply the peelable layer 11, the middle roller 82 would supply the foamed plastic layer 12 having an adhesive coating on its undersurface, and the upper roller 83 would supply the decorative layer 13.

The three sheets pass through laminating rollers 84 which produce the laminate 10 of FIG. 2.

Laminate 10 is then passed under an embossing device 85 carrying an embossing element 85a which bonds the three layers together.

The laminate is then passed through a separation machine 86 which may be constructed as described above to separate the extraneous scrap portion of the laminate to be removed in order to define the desired pattern. The extraneous scrap portion is removed by a scrap-collection roller 87 while the desired pattern portion passes under a quality monitor 88. The laminate is then passed under a carrier sheet applicator 89, which applies a carrier sheet, such as of cellophane, to the laminate. The carrier sheet with the laminate is then passed under a cutting press 90 which cuts the laminate into the individual units, such as emblems, nameplates, etc., which are fed to a collection device 91, while the carrier sheet is collected on a collection roll 92.

The rotary production line illustrated in FIG. 27, and therein generally designated 100, includes a turntable 101 for conveying the laminate from an inlet station 102 through a plurality of processing stations by the rotation of the turntable. Station 103 includes an embossing device for bonding together the various layers of the pattern portion of the decorative laminate. In station 104, the extraneous scrap portions (15a, 15b) are separated and removed; in station 105, the produced laminate is subject to a quality control operation; in station 106, the laminate is cut into the individual units, such as emblems; and in station 107, the individual units are removed with the desired pattern 14.

Some Variations and Other Applications of the Invention

While the invention has been described with respect to several preferred embodiments, it will be appreciated that these are set forth merely for purposes of example, and that many variations and other applications of the invention may be made. For example the produced decorative laminate could include several pattern portions, such as a series of letters or other designs, all retained on a common backing layer. In addition, the bonding of the various layers could be effected by fusion. Further, in a batch-type technique, the apparatus could process a number of decorative laminates simultaneously. The decorative laminate could also be produced as a continuous strip, to serve as a decorative trim strip or the like.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, patent applications and sequences identified by their accession numbers mentioned in this specification are herein incorporated in their entirety by reference into the specification, to the same extent as if each individual publication, patent, patent application or sequence identified by their accession number was specifically and individually indicated to be incorporated herein by reference. In addition, citation or identification of any reference in this application shall not be construed as an admission that such reference is available as prior ar to the present invention.

1. A method of making decorative articles having desired pattern thereon, comprising:
producing a decorative strip having a pattern portion of the desired pattern, and an extraneous scrap portion to be removed in order to define the desired pattern;
applying the decorative strip to a separation assembly including a pressure applicator engaging one side of the decorative strip and configured according to the scrap portion to be removed, and a counter-pressure device engaging the opposite side of the decorative strip and configured according to said pattern portion, so as to separate said scrap portion of the decorative strip from said pattern portion;
and removing said separated scrap portion.

2. The method according to claim 1, wherein said pressure applicator includes a plurality of pins having tips engagable with said one side of the decorative strip and arrayed according to the configuration of said scrap portion of the decorative sip to be removed.

3. The method according to claim 2, wherein said plurality of pins are adjustable in said pressure applicator to permit changing the configuration of the array of said pin tips.

4. The method according to claim 2, wherein said pressure applicator further includes a pressure member driven against the opposite ends of said plurality of pins to drive said tips against said one side of the decorative strip to separate said scrap portion from said pattern portion.

5. The method according to claim 4, wherein said pressure member is configured to drive all said pins simultaneously against said one side of the decorative strip.

6. The method according to claim 4, wherein said pressure member is configured to drive said pins at different times against said one side of the decorative strip to facilitate separation and removal of said scrap portion from said pattern portion.

7. The method according to claim 4, wherein said pressure member is driven by a piston movable within a cylinder.

8. The method according to claim 2, wherein said pressure applicator further includes a plurality of solenoids for driving said pins against said one side of the decorative strip.

9. The method according to claim 2, wherein said plurality of pins are carried by an apertured plate having a locking device for selectively locking and unlocking said pins with respect to said lured plate.

10. The method according to claim 1, wherein said counter-pressure device is in the form of a single member configured according to said pattern portion of the decorative strip to be retained.

11. The method according to claim 1, wherein said counter-pressure device includes a plurality of pins having tips engageable with said opposite side of the decorative strip and arrayed according to the configuration of said pattern portion of the decorative strip to be retained.

12. The method according to claim 1, wherein said decorative strip is a laminate including a plastic backing layer on said one side, and a colored layer on said opposite side.

13. The method according to claim 12, wherein said laminate further includes an adhesive coating on said backing layer, and a peelable layer over said adhesive coating.

14. Apparatus for making decorative strips having pattern portions of a desired pattern, and extraneous scrap portions to be removed in order to define the desired pattern; said apparatus comprising:
a separation device including a pressure applicator configured according to said scrap portion and engageable with one side of said decorative strip, and a counter-pressure device engageable with the opposite side of said decorative strip and configured according to said pattern portion;
and a drive for driving said pressure applicator towards said counter-pressure device to forcibly separate said scrap portion of the decorative strip from said pattern portion.

15. The apparatus according to claim 14, wherein said pressure applicator includes a plurality of pins having tips engageable with said one side of the decorative strip and arrayed according to the configuration of said scrap portion of the decorative strip to be removed.

16. The apparatus according to claim 15, wherein said plurality of pins are adjustable on said pressure applicator to permit changing the configuration of said pin tips.

17. The apparatus according to claim 15, wherein said pressure applicator further includes a pressure member driven against the opposite ends of said plurality of pins to drive said tips against said one side of the decorative strip to forcibly separate said scrap portion from said pattern portion of the decorative strip.

18. The apparatus according to claim 17, wherein said pressure member is configured to drive all said pins simultaneously against said one side of the decorative strip.

19. The apparatus according to claim 17, where said pressure member is configured to drive said pins at different times against said one side of the decorative strip to facilitate separation and removal of said scrap portion from the pattern portion.

20. The apparatus according to claim 15, wherein said pressure member is driven by a piston movable within a cylinder.

21. The apparatus according to claim 15, wherein said separation device further includes a locking mechanism for locking said pressure applicator and counter-pressure device together when the decorative strip is received between them.

22. The apparatus according to claim 15, wherein said pressure applicator further includes a plurality of solenoids for driving said pins against said one side of the laminate.

23. The apparatus according to claim 15, wherein said plurality of pins are carried by an apertured plate having a locking device for selectively locking and unlocking said pins with respect to said plate.

24. The apparatus according to claim 15, wherein said counter-pressure device is in the form of a single member configured according to said pattern portion of the decorative strip to be retained.

25. The apparatus according to claim 15, wherein said counter-pressure device includes a plurality of pins having tips engageable with said opposite side of the decorative strip and arrayed according to the configuration of said pattern portion of the decorative strip to be retained.

26. The apparatus according to claim 15, wherein said pins are preset and/or actuated under the control of a computer.
